(19) United States
(12) Patent Application Publication
(10) Pub. No.: US 2024/0257065 A1
(43) Pub. Date: Aug. 1, 2024

(54) INTELLIGENTLY MANAGING MULTIPLE CALENDAR BOOKINGS VIA A GROUP-BASED COMMUNICAITON PLATFORM

(71) Applicant: Salesforce, Inc., San Francisco, CA (US)

(72) Inventors: Vandit Garg, San Francisco, CA (US); Soumya Mittapalli, San Francisco, CA (US); Jose Garcia, San Francisco, CA (US); Peter Wu, San Francisco, CA (US)

(21) Appl. No.: 18/104,158

(22) Filed: Jan. 31, 2023

(51) Int. Cl. G06Q 10/1093

(52) U.S. Cl. CPC G06Q 10/1095

(57) ABSTRACT

Techniques for generating priority scores associated with meetings via group-based communication platforms are discussed herein. For example, a group-based communication platform may receive, from a user of the group-based communication platform, a request to generate a meeting between additional users of the group-based communication platform. The group-based communication platform may then input the request into a machine-learning model and receive a priority score associated with an importance of the meeting. Based at least in part on one or more calendars associated with the additional users, the group-based communication platform may determine an availability of the additional users. The group-based communication platform may then send, to the additional users, an invitation to the meeting including the priority score, and receive at least one response.

### TECHNICAL FIELD

Communication platforms are becoming increasingly more popular for organizations to facilitate communication and collaboration among and between users. Users of such communication platforms can communicate with one another via virtual spaces by sending data. In some cases, users may organize meetings between one another by scheduling meetings, such as via the virtual space. However, as collaboration via such communication platforms increases, users may find their calendars containing numerous meetings, some of which may overlap one another. As a result, users may forget to attend meetings, may be unaware of the importance of a meeting, or may be invited to meetings they are not required to attend.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates an example system for performing techniques described herein.

FIG. 2 illustrates an example process for generating a meeting invitation associated with a group-based communication platform.

FIG. 3 illustrates an example process for generating and sending meeting recommendations to users of a group-based communication platform.

FIG. 4 illustrates a flow diagram of an example process for generating a priority score associated with a meeting between users of a group-based communication platform.

FIG. 5 illustrates a flow diagram of an example process for generating and sending a meeting recommendation to users of a group-based communication platform.

### DETAILED DESCRIPTION

The ability to effectively and efficiently manage meetings presents many challenges. For example, many professionals utilize meetings to collaborate with colleagues, make important decisions, and share ideas. Traditionally, meetings required all attendees to physically be present in a singular location. However, online communication platforms, such as group-based communication platforms, have transformed the way in which professionals communicate with one another within the workforce. For example, by enabling users of such group-based communication platforms to conduct virtual meetings, users from across the globe are able to remotely attend meetings. While this ability has provided numerous benefits, it has also surfaced many challenges. For example, in the instance of larger-scale organizations and corporations consisting of interdependent teams and high numbers of workflows, it may be common for users to be booked for multiple meetings at overlapping times. This is problematic for both the meeting organizers and meeting invitees. When faced with selecting which meeting to attend when two or more meetings are booked at overlapping times, meeting invitees may be unsure of which meeting is more important to attend and may accidently attend a meeting of lesser importance. Not only does this diminish the efficacy of the meeting that the invitee was not in attendance, but meeting organizers often need to reschedule meetings in hopes that the next meeting will have improved attendance and participation.

Thus, this disclosure describes techniques for improving the efficacy of meeting management by providing meeting notifications to meeting invitees after a meeting has started but before the invitee has joined the meeting and providing both the meeting organizer and/or meeting invitee suggestions for future meetings to increase attendance. For instance, suppose a first user of a group-based communication platform generates a meeting between the first user of the group-based communication platform, a second user of the group-based communication platform, and a third user of the group-based communication platform. Utilizing a machine learning model, the communication platform may determine a priority score associated with the meeting, where the priority score may indicate an importance of the meeting. The communication platform may include the priority score in a meeting invitation sent to the first user, the second user, and the third user such that, when faced with two meetings scheduled at a same time, a user may attend the meeting with a greater importance, thereby maximizing a use of the user's time. Although the intelligent meeting management systems and processes described herein reference a group-based communication platform, it is contemplated that the systems/processes described herein may relate to any type of meeting between any type of user/organization.

Additionally or alternatively, the group-based communication platform may improve meeting attendance by notifying users when users have conflicting meetings scheduled. For example, the group-based communication platform may access one or more calendars of the first user, the second user, and/or the third user, and determine whether a meeting conflict exists between the first user, the second user, and/or the third user and the meeting. Based at least in part on determining a meeting conflict exists, the group-based communication platform may notify the first user, the second user, and/or the third user of the conflict, suggest a second time to schedule the meeting that the first user, the second user, and/or the third user are available, or automatically cancel the meeting, to name a few non-limiting examples.

Moreover, the group-based communication platform may provide recommendations for future meetings based at least in part on actions of users who have previously attended meetings. For example, the group-based communication platform may utilize metrics such as an average amount of time between the start of a meeting and a time that a user joins the meeting to recommend actions such as removing the user from future meetings.

As illustrated by these examples, the techniques described herein can improve the functioning, efficiency, and overall user experience of scheduling systems. For example, the techniques described herein improve current scheduling systems. As described above, traditional scheduling systems require users to manually determine when multiple overlapping meetings are scheduled. This often leads to meetings being lost or forgotten. Moreover, traditional scheduling systems require users to decide, without external input, which meeting to attend when multiple meetings overlap. This often leads to users selecting to attend meetings with lesser importance, reducing the meetings efficiency and requiring meetings missed by the user to be re-booked. The techniques described herein provide an enhanced scheduling system that may send intelligent notifications alerting users of multiple meeting bookings, indications of the importance of meetings, and suggestions to improve meeting efficiency and attendance for future meetings. For example, by providing users indications of multiple meetings scheduled for time, users are more likely to respond to the meeting invite in a timely manner, allowing meeting organizers a chance to consider rescheduling the meeting. Additionally, by using machine-learning models to calculate priority scores associated with meetings, users are provided with an accurate representation of an importance of a meeting, which the users may not be fully aware of or may not be able to fully calculate on their own. In this way, the techniques described herein solve a technical problem associated with determining a meeting to attend when multiple meetings are overlapping. Moreover, by analyzing user responses and behavior associated with meetings to generate meeting-specific user suggestions, the techniques described herein ensure that scheduling via communication platforms may continue to improve.

Thus, the scheduling platform described herein may reduce a total amount of network traffic by reducing a number of messages transmitted between a user scheduling a meeting and a user invited to the meeting to determine a time for the meeting. Rather than sending communications back and forth to determine a meeting time in which the majority of users are available, reminding users of the meeting time, following up with users who are not in attendance after the meeting has started, and re-scheduling meetings, the techniques described herein utilize machine-learning models to analyze user schedules and behavior, significantly reducing the time and data required.

The following detailed description of examples references the accompanying drawings that illustrate specific examples in which the techniques can be practiced. The examples are intended to describe aspects of the systems and methods in sufficient detail to enable those skilled in the art to practice the techniques discussed herein. Other examples can be utilized and changes can be made without departing from the scope of the disclosure. The following detailed description is, therefore, not to be taken in a limiting sense. The scope of the disclosure is defined only by the appended claims, along with the full scope of equivalents to which such claims are entitled.

### Group-Based Communication System

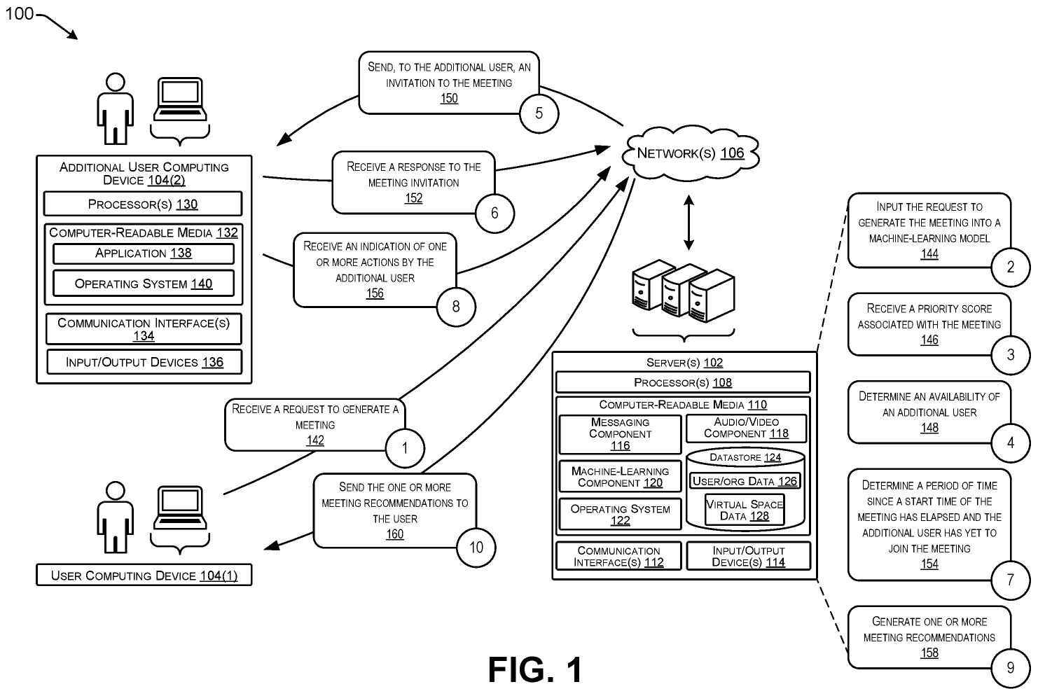

FIG. 1 illustrates an example environment 100 for performing techniques described herein. In at least one example, the example environment 100 can be associated with a communication platform that can leverage a network-based computing system to enable users of the communication platform to exchange data. In at least one example, the communication platform can be “group-based” such that the platform, and associated systems, communication channels, messages, collaborative documents, canvases, audio/video conversations, and/or other virtual spaces, have security (that can be defined by permissions) to limit access to a defined group of users. In some examples, such groups of users can be defined by group identifiers, as described above, which can be associated with common access credentials, domains, or the like. In some examples, the communication platform can be a hub, offering a secure and private virtual space to enable users to chat, meet, call, collaborate, transfer files or other data, or otherwise communicate between or among each other. As described above, each group can be associated with a workspace, enabling users associated with the group to chat, meet, call, collaborate, transfer files or other data, or otherwise communicate between or among each other in a secure and private virtual space. In some examples, members of a group, and thus workspace, can be associated with a same organization. In some examples, members of a group, and thus workspace, can be associated with different organizations (e.g., entities with different organization identifiers).

In at least one example, the example environment 100 can include one or more server computing devices (or “server(s)”) 102. In at least one example, the server(s) 102 can include one or more servers or other types of computing devices that can be embodied in any number of ways. For example, in the example of a server, the functional components and data can be implemented on a single server, a cluster of servers, a server farm or data center, a cloud-hosted computing service, a cloud-hosted storage service, and so forth, although other computer architectures can additionally or alternatively be used.

In at least one example, the server(s) 102 can communicate with a user computing device 104 via one or more network(s) 106. That is, the server(s) 102 and the user computing device 104 can transmit, receive, and/or store data (e.g., content, information, or the like) using the network(s) 106, as described herein. The user computing device 104 can be any suitable type of computing device, e.g., portable, semi-portable, semi-stationary, or stationary. Some examples of the user computing device 104 can include a tablet computing device, a smart phone, a mobile communication device, a laptop, a netbook, a desktop computing device, a terminal computing device, a wearable computing device, an augmented reality device, an Internet of Things (IoT) device, or any other computing device capable of sending communications and performing the functions according to the techniques described herein. While two user computing devices 104(1) and 104(2) are shown, in practice, the example environment 100 can include multiple (e.g., tens of, hundreds of, thousands of, millions of) user computing devices. Moreover, although the components of the additional user computing device 104(2) are shown, the user computing device 104(1) contains the same or similar components as the additional user computing device 104(2). In at least one example, user computing devices, such as the user computing device 104, can be operable by users to, among other things, access communication services via the communication platform. A user can be an individual, a group of individuals, an employer, an enterprise, an organization, and/or the like.

The network(s) 106 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Components used for such communications can depend at least in part upon the type of network, the environment selected, or both. Protocols for communicating over such network(s) 106 are well known and are not discussed herein in detail.

In at least one example, the server(s) 102 can include one or more processors 108, computer-readable media 110, one or more communication interfaces 112, and/or input/output devices 114.

In at least one example, each processor of the processor(s) 108 can be a single processing unit or multiple processing units, and can include single or multiple computing units or multiple processing cores. The processor(s) 108 can be implemented as one or more microprocessors, microcomputers, microcontrollers, digital signal processors, central processing units (CPUs), graphics processing units (GPUs), state machines, logic circuitries, and/or any devices that manipulate signals based on operational instructions. For example, the processor(s) 108 can be one or more hardware processors and/or logic circuits of any suitable type specifically programmed or configured to execute the algorithms and processes described herein. The processor(s) 108 can be configured to fetch and execute computer-readable instructions stored in the computer-readable media, which can program the processor(s) to perform the functions described herein.

The computer-readable media 110 can include volatile and nonvolatile memory and/or removable and non-removable media implemented in any type of technology for storage of data, such as computer-readable instructions, data structures, program modules, or other data. Such computer-readable media 110 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired data and that can be accessed by a computing device. Depending on the configuration of the server(s) 102, the computer-readable media 110 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 110 can be used to store any number of functional components that are executable by the processor(s) 108. In many implementations, these functional components comprise instructions or programs that are executable by the processor(s) 108 and that, when executed, specifically configure the processor(s) 108 to perform the actions attributed above to the server(s) 102. Functional components stored in the computer-readable media can optionally include a messaging component 116, an audio/video component 118, a machine-learning component 120, an operating system 122, and a datastore 124.

In at least one example, the messaging component 116 can process messages between users. That is, in at least one example, the messaging component 116 can receive an outgoing message from a user computing device 104 and can send the message as an incoming message to a second user computing device 104. The messages can include direct messages sent from an originating user to one or more specified users and/or communication channel messages sent via a communication channel from the originating user to the one or more users associated with the communication channel. Additionally, the messages can be transmitted in association with a collaborative document, canvas, or other collaborative space. In at least one example, the canvas can include a flexible canvas for curating, organizing, and sharing collections of information between users. In at least one example, the collaborative document can be associated with a document identifier (e.g., virtual space identifier, communication channel identifier, etc.) configured to enable messaging functionalities attributable to a virtual space (e.g., a communication channel) within the collaborative document. That is, the collaborative document can be treated as, and include the functionalities associated with, a virtual space, such as a communication channel. The virtual space, or communication channel, can be a data route used for exchanging data between and among systems and devices associated with the communication platform.

In at least one example, the messaging component 116 can establish a communication route between and among various user computing devices, allowing the user computing devices to communicate and share data between and among each other. In at least one example, the messaging component 116 can manage such communications and/or sharing of data. In some examples, data associated with a virtual space, such a collaborative document, can be presented via a user interface. In addition, metadata associated with each message transmitted via the virtual space, such as a timestamp associated with the message, a sending user identifier, a recipient user identifier, a conversation identifier and/or a root object identifier (e.g., conversation associated with a thread and/or a root object), and/or the like, can be stored in association with the virtual space.

In various examples, the messaging component 116 can receive a message transmitted in association with a virtual space (e.g., direct message instance, communication channel, canvas, collaborative document, etc.). In various examples, the messaging component 116 can identify one or more users associated with the virtual space and can cause a rendering of the message in association with instances of the virtual space on respective user computing devices 104. In various examples, the messaging component 116 can identify the message as an update to the virtual space and, based on the identified update, can cause a notification associated with the update to be presented in association with a sidebar of user interface associated with one or more of the user(s) associated with the virtual space. For example, the messaging component 116 can receive, from a first user account, a message transmitted in association with a virtual space. In response to receiving the message (e.g., interaction data associated with an interaction of a first user with the virtual space), the messaging component 116 can identify a second user associated with the virtual space (e.g., another user that is a member of the virtual space). In some examples, the messaging component 116 can cause a notification of an update to the virtual space to be presented via a sidebar of a user interface associated with a second user account of the second user. In some examples, the messaging component 116 can cause the notification to be presented in response to a determination that the sidebar of the user interface associated with the second user account includes an affordance associated with the virtual space. In such examples, the notification can be presented in association with the affordance associated with the virtual space.

In various examples, the messaging component 116 can be configured to identify a mention or tag associated with the message transmitted in association with the virtual space. In at least one example, the mention or tag can include an @mention (or other special character) of a user identifier that is associated with the communication platform. The user identifier can include a username, real name, or other unique identifier that is associated with a particular user. In response to identifying the mention or tag of the user identifier, the messaging component 116 can cause a notification to be presented on a user interface associated with the user identifier, such as in association with an affordance associated with the virtual space in a sidebar of a user interface associated with the particular user and/or in a virtual space associated with mentions and reactions. That is, the messaging component 116 can be configured to alert a particular user that they were mentioned in a virtual space.

In at least one example, the audio/video component 118 can be configured to manage audio and/or video communications between and among users. In some examples, the audio and/or video communications can be associated with an audio and/or video conversation. In at least one example, the audio and/or video conversation can include a discrete identifier configured to uniquely identify the audio and/or video conversation. In some examples, the audio and/or video component 118 can store user identifiers associated with user accounts of members of a particular audio and/or video conversation, such as to identify user(s) with appropriate permissions to access the particular audio and/or video conversation.

In some examples, communications associated with an audio and/or video conversation (“conversation”) can be synchronous and/or asynchronous. That is, the conversation can include a real-time audio and/or video conversation between a first user and a second user during a period of time and, after the first period of time, a third user who is associated with (e.g., is a member of) the conversation can contribute to the conversation. The audio/video component 118 can be configured to store audio and/or video data associated with the conversation, such as to enable users with appropriate permissions to listen and/or view the audio and/or video data.

In some examples, the audio/video component 118 can be configured to generate a transcript of the conversation, and can store the transcript in association with the audio and/or video data. In some examples, the audio/video may be be procured only with user and organization consent and permission. The transcript can include a textual representation of the audio and/or video data. In at least one example, the audio/video component 118 can use known speech recognition techniques to generate the transcript. In some examples, the audio/video component 118 can generate the transcript concurrently or substantially concurrently with the conversation. That is, in some examples, the audio/video component 118 can be configured to generate a textual representation of the conversation while it is being conducted. In some examples, the audio/video component 118 can generate the transcript after receiving an indication that the conversation is complete. The indication that the conversation is complete can include an indication that a host or administrator associated therewith has stopped the conversation, that a threshold number of meeting attendees have closed associated interfaces, and/or the like. That is, the audio/video component 118 can identify a completion of the conversation and, based on the completion, can generate the transcript associated therewith.

In at least one example, the audio/video component 118 can be configured to cause presentation of the transcript in association with a virtual space with which the audio and/or video conversation is associated. For example, a first user can initiate an audio and/or video conversation in association with a communication channel. The audio/video component 118 can process audio and/or video data between attendees of the audio and/or video conversation, and can generate a transcript of the audio and/or video data. In response to generating the transcript, the audio/video component 118 can cause the transcript to be published or otherwise presented via the communication channel. In at least one example, the audio/video component 118 can render one or more sections of the transcript selectable for commenting, such as to enable members of the communication channel to comment on, or further contribute to, the conversation. In some examples, the audio/video component 118 can update the transcript based on the comments.

In at least one example, the audio/video component 118 can manage one or more audio and/or video conversations in association with a virtual space associated with a group (e.g., organization, team, etc.) administrative or command center. The group administrative or command center can be referred to herein as a virtual (and/or digital) headquarters associated with the group. In at least one example, the audio/video component 118 can be configured to coordinate with the messaging component 116 and/or other components of the server(s) 102, to transmit communications in association with other virtual spaces that are associated with the virtual headquarters. That is, the messaging component 116 can transmit data (e.g., messages, images, drawings, files, etc.) associated with one or more communication channels, direct messaging instances, collaborative documents, canvases, and/or the like, that are associated with the virtual headquarters. In some examples, the communication channel(s), direct messaging instance(s), collaborative document(s), canvas(es), and/or the like can have associated therewith one or more audio and/or video conversations managed by the audio/video component 118. That is, the audio and/or video conversations associated with the virtual headquarters can be further associated with, or independent of, one or more other virtual spaces of the virtual headquarters.

In some examples, the communication platform can manage communication channels. In some examples, the communication platform can be a channel-based messaging platform, that in some examples, can be usable by group(s) of users. Users of the communication platform can communicate with other users via communication channels. A communication channel, or virtual space, can be a data route used for exchanging data between and among systems and devices associated with the communication platform. In some examples, a channel can be a virtual space where people can post messages, documents, and/or files. In some examples, access to channels can be controlled by permissions. In some examples, channels can be limited to a single organization, shared between different organizations, public, private, or special channels (e.g., hosted channels with guest accounts where guests can make posts but are prevented from performing certain actions, such as inviting other users to the channel). In some examples, some users can be invited to channels via email, channel invites, direct messages, text messages, and the like. Examples of channels and associated functionality are discussed throughout this disclosure.

In at least one example, the operating system 122 can manage the processor(s) 108, computer-readable media 110, hardware, software, etc. of the server(s) 102.

In at least one example, the datastore 124 can be configured to store data that is accessible, manageable, and updatable. In some examples, the datastore 124 can be integrated with the server(s) 102, as shown in FIG. 1. In other examples, the datastore 124 can be located remotely from the server(s) 102 and can be accessible to the server(s) 102 and/or user device(s), such as the user device 104. The datastore 124 can comprise multiple databases, which can include user/org data 126 and/or virtual space data 128. Additional or alternative data may be stored in the data store and/or one or more other data stores.

In at least one example, the user/org data 126 can include data associated with users of the communication platform. In at least one example, the user/org data 126 can store data in user profiles (which can also be referred to as “user accounts”), which can store data associated with a user, including, but not limited to, one or more user identifiers associated with multiple, different organizations or entities with which the user is associated, one or more communication channel identifiers associated with communication channels to which the user has been granted access, one or more group identifiers for groups (or, organizations, teams, entities, or the like) with which the user is associated, an indication whether the user is an owner or manager of any communication channels, an indication whether the user has any communication channel restrictions, a plurality of messages, a plurality of emojis, a plurality of conversations, a plurality of conversation topics, an avatar, an email address, a real name (e.g., John Doe), a username (e.g., j doe), a password, a time zone, a status, a token, and the like.

In at least one example, the user/org data 126 can include permission data associated with permissions of individual users of the communication platform. In some examples, permissions can be set automatically or by an administrator of the communication platform, an employer, enterprise, organization, or other entity that utilizes the communication platform, a team leader, a group leader, or other entity that utilizes the communication platform for communicating with team members, group members, or the like, an individual user, or the like. Permissions associated with an individual user can be mapped to, or otherwise associated with, an account or profile within the user/org data 126. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the communication platform by maintaining security for limiting access to a defined group of users. In some examples, such users can be defined by common access credentials, group identifiers, or the like, as described above.

In at least one example, the user/org data 126 can include data associated with one or more organizations of the communication platform. In at least one example, the user/org data 126 can store data in organization profiles, which can store data associated with an organization, including, but not limited to, one or more user identifiers associated with the organization, one or more virtual space identifiers associated with the organization (e.g., workspace identifiers, communication channel identifiers, direct message instance identifiers, collaborative document identifiers, canvas identifiers, audio/video conversation identifiers, etc.), an organization identifier associated with the organization, one or more organization identifiers associated with other organizations that are authorized for communication with the organization, and the like.

In at least one example, the virtual space data 128 can include data associated with one or more virtual spaces associated with the communication platform. The virtual space data 128 can include textual data, audio data, video data, images, files, and/or any other type of data configured to be transmitted in association with a virtual space. Non-limiting examples of virtual spaces include workspaces, communication channels, direct messaging instances, collaborative documents, canvases, and audio and/or video conversations. In at least one example, the virtual space data can store data associated with individual virtual spaces separately, such as based on a discrete identifier associated with each virtual space. In some examples, a first virtual space can be associated with a second virtual space. In such examples, first virtual space data associated with the first virtual space can be stored in association with the second virtual space. For example, data associated with a collaborative document that is generated in association with a communication channel may be stored in association with the communication channel. For another example, data associated with an audio and/or video conversation that is conducted in association with a communication channel can be stored in association with the communication channel.

As discussed above, each virtual space of the communication platform can be assigned a discrete identifier that uniquely identifies the virtual space. In some examples, the virtual space identifier associated with the virtual space can include a physical address in the virtual space data 128 where data related to that virtual space is stored. A virtual space may be “public,” which may allow any user within an organization (e.g., associated with an organization identifier) to join and participate in the data sharing through the virtual space, or a virtual space may be “private,” which may restrict data communications in the virtual space to certain users or users having appropriate permissions to view. In some examples, a virtual space may be “shared,” which may allow users associated with different organizations (e.g., entities associated with different organization identifiers) to join and participate in the data sharing through the virtual space. Shared virtual spaces (e.g., shared channels) may be public such that they are accessible to any user of either organization, or they may be private such that they are restricted to access by certain users (e.g., users with appropriate permissions) of both organizations.

In some examples, the datastore 124 can be partitioned into discrete items of data that may be accessed and managed individually (e.g., data shards). Data shards can simplify many technical tasks, such as data retention, unfurling (e.g., detecting that message contents include a link, crawling the link's metadata, and determining a uniform summary of the metadata), and integration settings. In some examples, data shards can be associated with organizations, groups (e.g., workspaces), communication channels, users, or the like.

In some examples, individual organizations can be associated with a database shard within the datastore 124 that stores data related to a particular organization identification. For example, a database shard may store electronic communication data associated with members of a particular organization, which enables members of that particular organization to communicate and exchange data with other members of the same organization in real time or near-real time. In this example, the organization itself can be the owner of the database shard and has control over where and how the related data is stored. In some examples, a database shard can store data related to two or more organizations (e.g., as in a shared virtual space).

In some examples, individual groups can be associated with a database shard within the datastore 124 that stores data related to a particular group identification (e.g., workspace). For example, a database shard may store electronic communication data associated with members of a particular group, which enables members of that particular group to communicate and exchange data with other members of the same group in real time or near-real time. In this example, the group itself can be the owner of the database shard and has control over where and how the related data is stored.

In some examples, a virtual space can be associated with a database shard within the datastore 124 that stores data related to a particular virtual space identification. For example, a database shard may store electronic communication data associated with the virtual space, which enables members of that particular virtual space to communicate and exchange data with other members of the same virtual space in real time or near-real time. As discussed above, the communications via the virtual space can be synchronous and/or asynchronous. In at least one example, a group or organization can be the owner of the database shard and can control where and how the related data is stored.

In some examples, individual users can be associated with a database shard within the datastore 124 that stores data related to a particular user account. For example, a database shard may store electronic communication data associated with an individual user, which enables the user to communicate and exchange data with other users of the communication platform in real time or near-real time. In some examples, the user itself can be the owner of the database shard and has control over where and how the related data is stored.

In some examples, such as when a channel is shared between two organizations, each organization can be associated with its own encryption key. When a user associated with one organization posts a message or file to the shared channel it can be encrypted in the datastore 124 with the encryption key specific to the organization and the other organization can decrypt the message or file prior to accessing the message or file. Further, in examples where organizations are in different geographical areas, data associated with a particular organization can be stored in a location corresponding to the organization and temporarily cached at a location closer to a client (e.g., associated with the other organization) when such messages or files are to be accessed. Data can be maintained, stored, and/or deleted in the datastore 124 in accordance with a data governance policy associated with each specific organization.

The communication interface(s) 112 can include one or more interfaces and hardware components for enabling communication with various other devices (e.g., the user computing device 104), such as over the network(s) 106 or directly. In some examples, the communication interface(s) 112 can facilitate communication via WebSockets, Application Programming Interfaces (APIs) (e.g., using API calls), Hypertext Transfer Protocols (HTTPS), etc.

The server(s) 102 can further be equipped with various input/output devices 114 (e.g., I/O devices). Such I/O devices 114 can include a display, various user interface controls (e.g., buttons, joystick, keyboard, mouse, touch screen, etc.), audio speakers, connection ports and so forth.

In at least one example, the user computing device 104 can include one or more processors 130, computer-readable media 132, one or more communication interfaces 134, and input/output devices 136.

In at least one example, each processor of the processor(s) 130 can be a single processing unit or multiple processing units, and can include single or multiple computing units or multiple processing cores. The processor(s) 130 can comprise any of the types of processors described above with reference to the processor(s) 108 and may be the same as or different than the processor(s) 108.

The computer-readable media 132 can comprise any of the types of computer-readable media 132 described above with reference to the computer-readable media 110 and may be the same as or different than the computer-readable media 110. Functional components stored in the computer-readable media can optionally include at least one application 138 and an operating system 140.

In at least one example, the application 138 can be a mobile application, a web application, or a desktop application, which can be provided by the communication platform or which can be an otherwise dedicated application. In some examples, individual user computing devices associated with the environment 100 can have an instance or versioned instance of the application 138, which can be downloaded from an application store, accessible via the Internet, or otherwise executable by the processor(s) 130 to perform operations as described herein. That is, the application 138 can be an access point, enabling the user computing device 104 to interact with the server(s) 102 to access and/or use communication services available via the communication platform. In at least one example, the application 138 can facilitate the exchange of data between and among various other user computing devices, for example via the server(s) 102. In at least one example, the application 138 can present user interfaces, as described herein. In at least one example, a user can interact with the user interfaces via touch input, keyboard input, mouse input, spoken input, or any other type of input.

In at least one example, the operating system 140 can manage the processor(s) 130, computer-readable media 132, hardware, software, etc. of the server(s) 102.

The communication interface(s) 134 can include one or more interfaces and hardware components for enabling communication with various other devices (e.g., the user computing device 104), such as over the network(s) 106 or directly. In some examples, the communication interface(s) 134 can facilitate communication via WebSockets, APIs (e.g., using API calls), HTTPs, etc.

The user computing device 104 can further be equipped with various input/output devices 136 (e.g., I/O devices). Such I/O devices 136 can include a display, various user interface controls (e.g., buttons, joystick, keyboard, mouse, touch screen, etc.), audio speakers, connection ports and so forth.

FIG. 1 further illustrates an example system for improving the efficacy of meeting management by providing meeting notifications to meeting invitees after a meeting has started but before the invitee has joined the meeting and providing both the meeting organizer and/or meeting invitee suggestions for future meetings in an effort to increase attendance. For example, at operation 142 (indicated by a “1”), the group-based communication platform may receive, from a user associated with the group-based communication platform, a request to generate a meeting between additional users of the group-based communication platform. In some examples, the user associated with a group-based communication platform may or may not be a participant of the meeting. For example, the user may be tasked with generating the meeting, but may not be invited to attend the meeting. In other examples, the user may both request the meeting and have an option of attending the meeting. In some examples, the group-based communication platform may receive the request via the group-based communication platform, such as via a calendar associated with the group-based communication platform.

At operation 144 (indicated by a “2”), the group-based communication platform may input the request to generate the meeting into a machine-learning model. For example, the machine-learning model may be trained to determine a priority score associated with the meeting. The priority score is described in further detail, below. In some examples, the machine-learning model may build a mathematical model using training data that includes priority scores that have been previously associated with previous meetings. For example, training data may include one or more meetings that have been previously conducted via the group-based communication platform and may be associated with one or more factors associated with the meeting, as described below. For example, the machine-learning model may receive, as input, various factors associated with previously conducted meetings in order to refine and train the model. Such factors may include, to name a few non-limiting examples previous meeting invitations including a number of invitees and their respective roles and/or positions), determining who did and/or did not attend the meeting, determining who arrived late to the meeting, determining whether reminders were sent for folks that were not present at a start of the meeting, and determining who joined/did not join the meeting after the reminders were sent. Additional factors like meeting duration, administrator priority overrides, meeting title and description, meeting importance, etc. may also be considered as inputs to the machine-learning model.

The machine-learning model may take a variety of forms. For instance, the machine-learning model may be an artificial neural network trained to define a score associated with the importance of a meeting. For example, the machine-learned model may receive one or more factors associated with a meeting and using key factors, output one or more scores associated with the one or more factors. The machine-learned model may compare the one or more scores associated with the one or more factors, and based at least in part on determining the highest score associated with the one or more factors, determine a priority score associated with the meeting.

Accordingly, the machine-learned model may include a number of additional or alternative classifiers to analyze the different content types of meeting requests received from the user. For example, the machine-learned model may include an artificial neural network including a speech recognition classifier trained to analyze speech or other audio included in a meeting request to determine one or more factors associated with the meeting. As another example, the machine-learned model may include a text classifier, such as an artificial neural network, trained to identify one or more topics associated with the meeting. Further, the machine-learned model may include an optical character recognition (OCR) classifier, which when given an image representing printed text (e.g., in a GIF, sticker, characters traced onto a touch screen using a finger or stylus, etc.), determines the corresponding text. The OCR classifier may output the text to a text classifier trained to identify one or more factors, as described above.

Although specific machine-learned models are described above, other types of machine-learned models can additionally or alternatively be used. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like.

At operation 146 (indicated by a “3”), the group-based communication platform may receive, from the machine-learning model, a priority score associated with the meeting. In some examples, the priority score may represent a determined importance of the meeting. For example, the priority score may be a numerical score, wherein a higher numerical score may correspond to a higher priority score, and thus a higher relative importance of the meeting. In other examples, the priority score may be designated a label corresponding to the priority (e.g., high priority, medium priority, and/or low priority), to name a few non-limiting examples. Numeric priority scores may also be associated with priority labels (e.g., 5=critical, 4=high, 3=medium, and so on).

In some examples, the priority score may be based on various factors associated with the meeting such as, for example, an urgency associated with the meeting (for example, a meeting may be labeled by the user as “high urgency” or “low urgency,” wherein a higher urgency corresponds to a higher priority score and a lower urgency corresponds to a lower priority score); a priority associated with the meeting (for example, a meeting may be labeled by the user as “high priority” or “low priority,” wherein a higher priority may corresponds to a higher priority score and a lower priority corresponds to a lower priority score); a scheduled duration of the meeting (for example, a shorter meeting duration may correspond to a higher priority score and a longer meeting may correspond to a lower priority score); a reoccurrence of the meeting (for example, a meeting may be scheduled to occur more than once, wherein a recurring meeting may correspond to a higher priority score and a single-instance meeting may correspond to a lower priority score); a type of reoccurrence of the meeting (for example, a weekly, bi-weekly, monthly, yearly, etc., wherein a less frequently scheduled meeting may correspond to a higher priority score and a more frequently scheduled meeting may correspond to a lower priority score); and/or a highest position or role of an additional user of the one or more additional users (for example, a meeting in which a C-suite executive is invited may correspond to a higher priority score and a meeting between associates may have a lower priority score); a ratio of higher-positioned additional users to lower-positioned users (for example, meeting with a 1:1 executive-level employee to associate-employee ratio, or a 1:1000 executive-level employee to associate-employee ratio, wherein higher executive-level employee to associate-employee ratio may correspond to a higher priority score and a lower executive-level employee to associate-employee ratio may correspond to a lower priority score); and/or an amount of additional users invited to the meeting (for example, a meeting containing a lower number of users invited to the meeting may correspond to a higher priority score and a meeting containing a higher number of users invited to the meeting may correspond to a lower priority score), to name a few non-limiting examples. Note, however, that these are non-limited examples, and any factor or combination of factors may be used in determining the priority score. Moreover, various factors may have various weights assigned, such that some factors may be weighed more heavily in favor of a higher priority score or a lower priority score. Additionally, factors in determining priority scores may be determined by any user of the group-based communication system.

In some examples, the user may wish to override the priority score provided by the machine-learning model. For example, although the machine-learning model may calculate a priority score indicating a medium importance, the user may have knowledge unavailable to the machine-learning model and may decide to update the priority score to a high importance. For instance, the priority score provided by the machine-learning model may be a first priority score. The group-based communication platform may then receive, from the user, an indication to update the first priority score and a second priority score associated with the meeting. Based at least in part on receiving the indication to update the first priority score, the group-based communication platform may then update the first priority score to the second priority score. In this way, users organizing meetings may have the ability to manually alter and assign priority scores associated with meetings, ensuring meetings are labeled as accurately as possible. In some examples, when a user overrides the group-based communication platform generated priority score, the group-based communication platform will keep track of this override. Such priority overrides may also be an input into the ML engine within the group-based communication platform that computes priority scores.

At operation 148 (indicated by a “4”), the group-based communication platform may determine, based at least in part on one or more calendars associated with the one or more additional users, an availability of the one or more additional users. For example, the one or more additional users may utilize one or more calendars provided by the group-based communication platform. Additionally, or alternatively, the group-based communication platform may access one or more calendars associated with the one or more additional users but un-associated with the group-based communication platform. In this way, the group-based communication platform may ensure an accurate representation of the availability of the additional users, allowing the group-based communication platform to make accurate determinations and recommendations regarding an availability of the additional users.

At operation 150 (indicated by a “5”), the group-based communication platform may send, to the one or more additional users, an invitation to the meeting.

Additionally, in some examples, the invitation may include the priority score, allowing the additional users to understand an importance associated with the meeting. For example, an additional user may be invited to a meeting but may not be aware of the context of the meeting, let alone the importance of attending the meeting. By providing the priority score associated with the meeting in the meeting invitation, additional users are encouraged to attend the meeting, or are at least provided the information/ability to decide whether they should attend the meeting.

In some examples, the group-based communication platform may determine a conflict with a time of the meeting. For example, the group-based communication platform may determine that an additional user has a conflict with the meeting. The group-based communication platform may then send, based at least in part on determining that the additional user has the conflict with the meeting and to at least one of the user and/or the additional user, a notification of the conflict.

In some examples, the group-based communication platform may suggest new times for a meeting based on availabilities of the additional users. For example, the request to generate the meeting may be associated with a first time. In some examples, the group-based communication platform may determine that a number of the additional users is below a threshold number of users (for example, 5 users, 10 users, 15 users, etc.). The group-based communication platform may then determine, based at least in part on the one or more calendars, a second meeting time, wherein the second meeting time is associated with an available time for one or more of the additional users. The group-based communication platform may then, in some examples, send, to the user and/or the additional users, the second meeting time as a suggested new meeting time.

At operation 152 (indicated by a “6”), the group-based communication platform may receive at least one response to the invitation from at least one additional user of the one or more additional users. In some examples, the at least one response may include at least one of a first indication to accept the invitation, a second indication to decline the invitation; and/or, a third indication of a proposed new time to associate with the meeting.

At operation 154 (indicated by a “7”), the group-based communication platform may determine that a period of time since a start time of the meeting has elapsed (e.g., 1 minute, 5 minutes, 10 minutes, etc.—such time intervals can be configured based on organization or team policies as inputs to the group-based communication platform) and that an additional user has yet to join the meeting. In some examples, the period of time may be determined by any user of the group-based communication platform, such as the user. Based at least in part on determining that the period of time since the start time of the meeting has elapsed and that the additional user of the one or more additional users has yet to join the meeting, the group-based communication platform may send a meeting reminder to the additional user. The meeting reminder may be sent via any type of notification such as, for example, an email, a mobile push-notification, and/or a short-message service (SMS), to name a few non-limiting examples. The manner in which the meeting reminder is sent to the additional user may be dictated by the user that organized the meeting, a policy set forth by the group-based communication platform and/or an organization associated with the additional user, and/or preferences explicitly or implicitly provided by the additional user.

In some examples, the notification may include one or more selectable controls enabling the additional user to send, to the user, a message associated with the meeting (for example, a message that the additional user is running late to the meeting). For example, the meeting reminder may include, in some examples, a selectable control associated with sending, to the user, at least one of a first indication that the additional user is running late, a second indication that the additional user will not attend the meeting, and/or a third indication that the additional user has a meeting conflict with the meeting.

In some examples, the group-based platform may send additional reminders to the additional user. For example, the period of time may be a first period of time and the meeting reminder may be a first meeting reminder sent at a first time. In some examples, the group-based communication platform may determine, at a second time subsequent the first time, that the additional user has not yet joined the meeting. The group-based communication platform may then determine that a second period of time since the start of the meeting and/or since an expiration of the first period of time has elapsed. Similar to the first period of time, the second period of time may be determined by any user of the group-based communication platform, such as the user. In some examples, the group-based communication platform may then send, to the additional user, a second reminder to join the meeting. The number of reminders sent by the group-based communication platform may be configured by the organization or the team as an input to the group-based communication platform.

In some examples, the user may further define attributes associated with additional users who may receive reminders from the group-based communication platform. For example, the group-based communication platform may receive, from the user, one or more attributes associated with an additional user. The one or more attributes may include actions or inactions taken by the additional user that may be indicative of whether the additional user may need a meeting reminder. For example, the one or more attributes include at least one of: a threshold number of meetings previously missed by the additional user, an average amount of time between a first start of one or more first previous meetings and the additional user joining the one or more first previous meetings being equal to or greater than a first threshold amount of time, and/or a total amount time between a second start of one or more second previous meetings and the additional user joining the one or more second previous meetings being equal to or greater than a second threshold amount of time, to name a few non-limiting examples. In some examples, the group-based communication platform may then determine that the additional user is associated with the one or more attributes, wherein sending the meeting reminder to the additional user is based at least in part on determining that the additional user is associated with the one or more attributes.

At operation 156 (indicated by a “8”), the group-based communication platform may receive an indication of one or more actions of the additional user in association with the meeting. In some examples, actions may indicate, to the group-based communication platform, that an additional user's invitation to a meeting may be reassessed for meeting efficiency. Actions may include, for example, attending the meeting, being absent from the meeting, joining the meeting after receiving the meeting reminder; and/or a duration of time between the start time of the meeting and the additional user joining the meeting, to name a few non-limiting examples.

At operation 158 (indicated by a “9”), the group-based communication platform may generate, based at least in part on the indication of the one or more actions of the additional user and a determination that a current time is past an end time of the meeting, one or more meeting recommendations associated with the additional user.

The one or more meeting recommendations may include, for example, suggestions directed to the user and/or the additional user to improve the efficiency of future meetings. For example, the group-based communication platform may suggest, to the user, to remove the additional user from future meetings associated with the group-based communication platform.

At operation 160 (indicated by a “10”), the group-based communication platform may send the one or more meeting recommendations to at least one of the users or the additional user. In this way, the group-based communication platform may provide users with resources to maximize meeting productivity and efficiency.

While techniques described herein are described as being performed by the messaging component 116, the audio/video component 118, the workspace management component 120, and the application 138, techniques described herein can be performed by any other component, or combination of components, which can be associated with the server(s) 102, the user computing device 104, or a combination thereof.

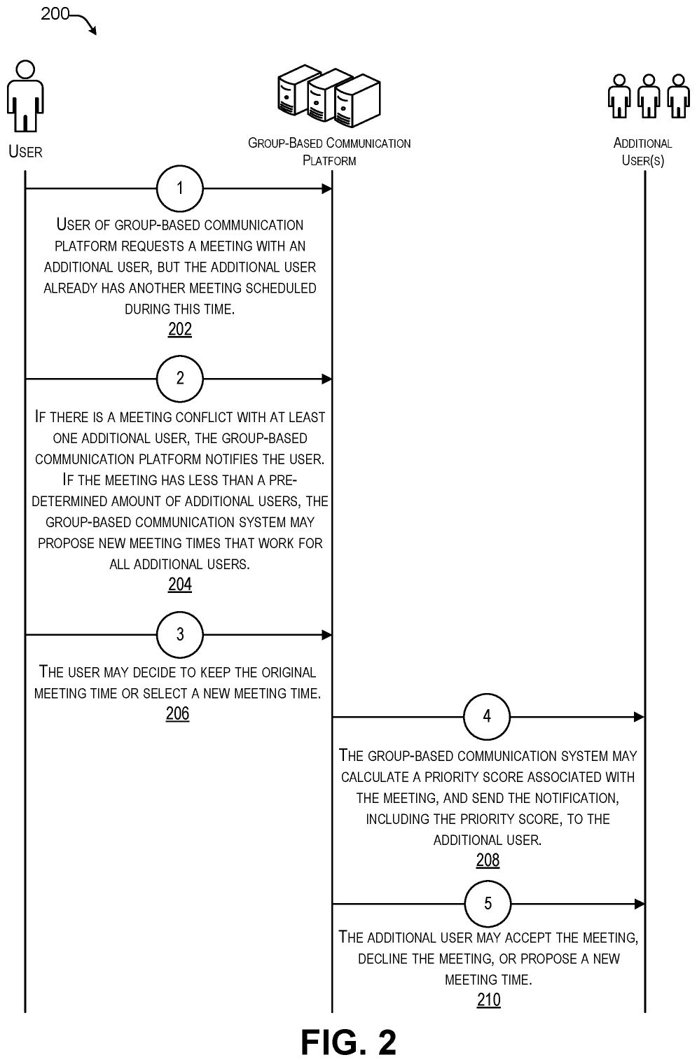

FIG. 2 illustrates an example process 200 for generating a meeting invitation associated with a group-based communication platform. For example, at operation 202 (indicated by “2”), the group-based communication may receive a request from a user of the group-based communication platform to generate a meeting with an additional user of the group-based communication platform. However, based at least in part on determining one or more schedules associated with the additional user, the group-based communication platform may determine that the additional user may already have another meeting scheduled during a time associated with the proposed meeting.

At operation 204 (indicated by “2”), the group-based communication system may notify the user of the meeting conflict between the additional user and the time associated with the proposed meeting, thereby allowing the user an opportunity to select a different time to schedule the meeting. In other examples, the group-based communication system may determine a number of additional users invited to the meeting. Based at least in part on determining that the number of additional users invited to the meeting is less than a predetermined number of additional users, the group-based communication system may propose one or more meeting times that work for the additional users.

At operation 206 (indicated by “3”), the user may decide to keep the original meeting time. Alternatively, the user may decide to select a new time to schedule the meeting such that the additional users may all attend. The group-based communication platform may keep a track of the selection made by the user and may use it as an input to the ML-engine within the group-based communication platform.

At operation 208 (indicated by “4”), the group-based communication system may send the invitation to the meeting. In some examples, if necessary, the group-based communication system may additionally notify the additional user of any meeting conflicts. In some examples, the group-based communication platform may calculate a priority score associated with the meeting and include the priority score in the meeting invitation. The priority score may be a number which may represent an importance or a priority of the meeting. For example, priority scores may range from 1 (meeting optional) to 5 (meeting urgent). The priority score may be based on a variety of factors such as a number of users invited to a meeting, a duration of a meeting, and/or a reoccurrence of a meeting.

At operation 210 (indicated by “5”), the additional user may respond to the meeting invitation. For example, the additional user may accept the meeting, decline the meeting, or propose a new meeting time, to name a few non-limiting examples. The group-based communication platform may keep track of the user's choice and use it as an input to the ML-engine within the group-based communication platform.

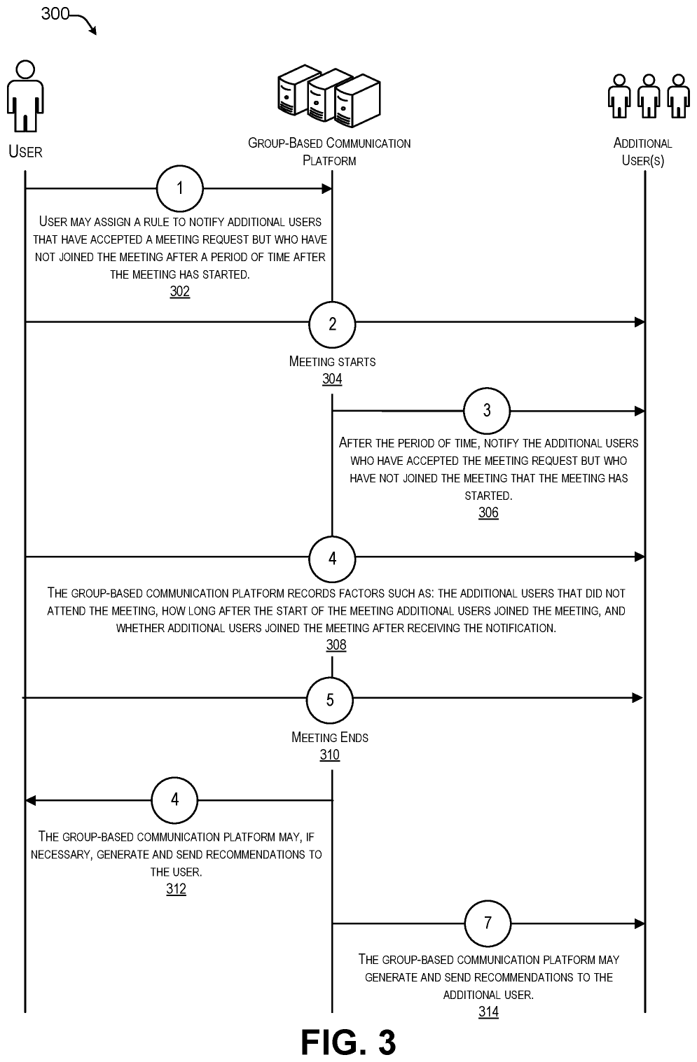

FIG. 3 illustrates an example process 300 for generating and sending meeting recommendations to users of a group-based communication platform. The example process 300 may include any or all operations as described in example process 200, described above.

For example, at operation 302 (indicated by “1”), a user of a group-based communication platform may assign a rule to notify additional users of the group-based communication platform that have accepted a meeting request but who have not joined the meeting after a period of time. For example, the user may select a period of time such as 5 minutes.

At operation 304 (indicated by “2”), the group-based communication platform may determine that the meeting has started.

At operation 306 (indicated by “3”), the group-based communication platform may determine that the period of time has elapsed from the start time of the meeting. Based at least in part on determining that the period of time has elapsed, the group-based communication platform may notify the additional users who have accepted the meeting request but who have not yet joined the meeting that the meeting has started.

At operation 308 (indicated by “4”), the group-based communication platform may record factors associated with an additional user's involvement in the meeting such as: the additional users that did not attend the meeting, how long after the start of the meeting additional users joined the meeting, and whether additional users joined the meeting after receiving the notification.

At operation 310 (indicated by “5”), the group-based communication platform may determine that the meeting has ended.

At operation 312 (indicated by “6”), the group-based communication platform may generate and send recommendations to the user regarding the meeting, as well as future meetings including at least one of the additional users that were invited to the meeting. Recommendations may include, for example, suggesting disinviting the additional user from future meetings, scheduling a time to discuss the additional user's attendance at previous and/or future meetings, coordinating with a supervisor of the additional user, seeking input from the additional user regarding the content discussed during, or otherwise associated with, the meeting, identifying different times in which the additional user has greater availability for future meetings, seeking input from the additional user regarding preferred meeting times, increasing or decreasing the number of invited attendees for future meetings in which the additional user is to be invited, changing the composition of users that attend the future meetings with the additional user, and/or suggesting the user notify the additional user of future meetings, including determining the appropriate cadence, type, and/or frequency of such reminders to the additional user.

At operation 314 (indicated by “7”), the group-based communication platform may generate and send recommendations to the additional user regarding the meeting.

Recommendations may include, for example, receiving, from the group-based communication platform, notifications that the additional user is late to future meetings, or suggesting declining future meetings.

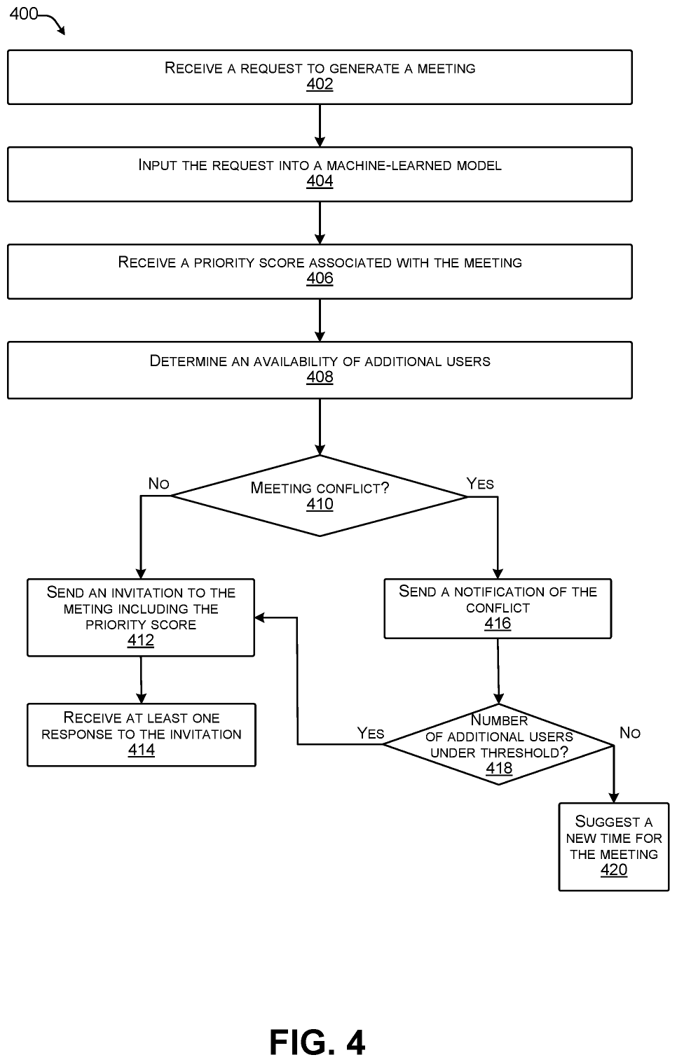

FIG. 4 illustrates a flow diagram of an example process 400 for generating a priority score associated with a meeting between users of a group-based communication platform.

For example, at operation 402, the process 400 may include at least receiving, from a user associated with a group-based communization platform, a request to generate a meeting between additional users of the group-based communication platform. For example, the group-based communication platform may receive the request via the group-based communication platform, such as via a calendar associated with the group-based communication platform.

At operation 404, the process 400 may include inputting the request to generate the meeting into a machine-learning model. For example, the machine-learning model may build a mathematical model using training data that includes priority scores that have been previously associated with a meeting. For example, training data may include on or more meetings that have been previously conducted via the group-based communication platform and may be associated with one or more factors associated with the meeting, as described below. The machine-learning model may take a variety of forms. For instance, the machine-learning model may be an artificial neural network trained to define a score associated with the importance of a meeting. For example, the machine-learned model may receive one or more factors associated with a meeting and using key factors, output one or more scores associated with the one or more factors. The machine-learned model may compare the one or more scores associated with the one or more factors, and based at least in part on determining the highest score associated with the one or more factors, determine a priority score associated with the meeting.

At operation 406, the process 400 may include receiving, from the machine-learning model, a priority score associated with the meeting. In some examples, the priority score may represent a determined importance of the meeting. For example, the priority score may be a numerical score, wherein a higher numerical score may correspond to a higher priority score. In other examples, the priority score may be designated a label corresponding to the priority (e.g., high priority, medium priority, and/or low priority), to name a few non-limiting examples.

At operation 408, the process 400 may include determining, based at least in part on one or more calendars associated with the one or more additional users, an availability of the one or more additional users. For example, the one or more additional users may utilize one or more calendars provided by the group-based communication platform. Additionally, or alternatively, the group-based communication platform may access one or more calendars associated with the one or more additional users but un-associated with the group-based communication platform. In this way, the group-based communication platform may ensure an accurate representation of the availability of the additional users, allowing the group-based communication platform to make accurate determinations and recommendations regarding an availability of the additional users.

At operation 410, the process 400 may include determining, by the group-based communication platform, a conflict with a time associated with the meeting. For example, the group-based communication platform may determine that an additional user has a conflict with the meeting. Based at least in part on determining that there is not a meeting conflict (“No” at operation 410), the process 400, at operation 412, may include sending, to the one or more additional users, an invitation to the meeting.

At operation 414, the process 400 may include receiving at least one response to the invitation from at least one additional user of the one or more additional users. In some examples, the at least one response may include at least one of a first indication to accept the invitation, a second indication to decline the invitation; and/or, a third indication of a proposed new time to associate with the meeting.

Alternatively, at operation 410, the group-based communication platform may determine there is a meeting conflict between an additional user and the meeting (“Yes” at operation 410). Thus, at the process at operation 416, the group-based communication platform may then send, based at least in part on determining that the additional user has the conflict with the meeting and to at least one of the user and/or the additional user, a notification of the conflict.

At operation 418, the process 400 may include determining, by the group-based communication platform, that a number of additional users is under a threshold number of users (“Yes” at operation 418). Thus, the process 400 may include sending the invitation to the meeting to the additional users, wherein the meeting includes the priority score.

Alternatively, the group-based communication platform may determine that the number of additional users is under the threshold (“No” at operation 418). Thus, the process 400 may include, at operation 420, suggesting a new time for the meeting. For example, the group-based communication platform may determine, based at least in part on the one or more calendars, a second meeting time, wherein the second meeting time is associated with an available time for one or more of the additional users. The group-based communication platform may then, in some examples, send, to the user and/or the additional users, the second meeting time as a suggested new meeting time.

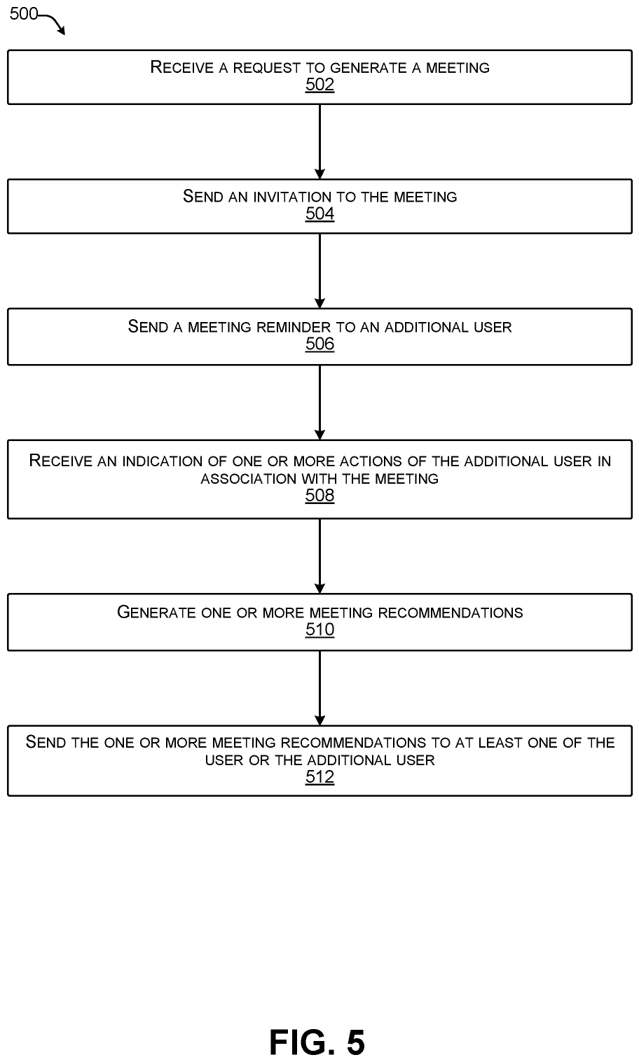

FIG. 5 illustrates a flow diagram of an example process 500 for generating and sending a meeting recommendation to users of a group-based communication platform. For example, at operation 502, the process 500 may include at least receiving, from a user associated with the group-based communication platform, a request to schedule a meeting between additional users of the group-based communication platform.

At operation 504, the process 500 may include at least sending, to the additional users, an invitation to the meeting. In some examples, the invitation may be sent via email, SMS, or push-notification, to name a few non-limiting examples.

At operation 506, the process 500 may include at least sending, based at least in part on determining that a period of time since a start time of the meeting has elapsed and that an additional user has yet to join the meeting, a meeting reminder to the additional user. In some examples, the period of time may be determined by any user of the group-based communication platform, such as the user. Based at least in part on determining that the period of time since the start time of the meeting has elapsed and that the additional user of the one or more additional users has yet to join the meeting, the group-based communication platform may send a meeting reminder to the additional user. Similar to the meeting invitation, the meeting reminder may be sent via any type of notification such as, for example, an email, a mobile push-notification, and/or a short-message service (SMS), to name a few non-limiting examples.

At operation 508, the process 500 may include at least receiving an indication of one or more actions of the additional user in association with the meeting. In some examples, actions may indicate, to the group-based communication platform, that an additional user's invitation to a meeting may be reassessed for meeting efficiency. Actions may include, for example, attending the meeting, being absent from the meeting, joining the meeting after receiving the meeting reminder; and/or a duration of time between the start time of the meeting and the additional user joining the meeting, to name a few non-limiting examples.

At operation 510, the process 500 includes at least generating, based at least in part on the indication of the one or more actions of the additional user and a determination that a current time is past an end time of the meeting, one or more meeting recommendations associated with the additional user. The one or more meeting recommendations may include, for example, suggestions directed to the user and/or the additional user to improve the efficiency of future meetings. For example, the group-based communication platform may suggest, to the user, to remove the additional user from future meetings associated with the group-based communication platform.

At operation 512, the process 500 includes at least sending the one or more meeting recommendations to at least one of the users or the additional user. In this way, the group-based communication platform may provide users with resources to maximize meeting productivity and efficiency.

### Example Clauses

While the example clauses described above are described with respect to one particular implementation, it should be understood that, in the context of this document, the content of the example clauses can also be implemented via a method, device, system, a computer-readable medium, and/or another implementation. Additionally, any of examples A-AN may be implemented alone or in combination with any other one or more of the examples A-AN.

A: A method, implemented at least in part by one or more computing devices of a group-based communication platform, the method comprising: receiving, from a user associated with the group-based communication platform, a request to generate a meeting between additional users of the group-based communication platform, wherein the user is included in, or excluded from, the additional users; inputting the request to generate the meeting into a machine-learning model; receiving, from the machine-learning model, a priority score associated with the meeting, wherein the priority score represents a determined importance of the meeting; determining, based at least in part on one or more calendars associated with the additional users, an availability of the additional users; sending, to the additional users, an invitation to the meeting, wherein the invitation includes the priority score; and receiving at least one response to the invitation from at least one additional user of the additional users.

B: The method of paragraph A, wherein the priority score is based at least in part on at least one of: an urgency associated with the meeting; a priority associated with the meeting; a duration of the meeting; a reoccurrence of the meeting; or a position or role of an additional user of the additional users.

C: The method of paragraph A, wherein the priority score is a first priority score, the method further comprising: receiving, from the user, an indication to update the first priority score; receiving, from the user, a second priority score associated with the meeting; and based at least in part on receiving the indication to update the first priority score, updating the first priority score to the second priority score.

D: The method of paragraph A, further comprising: determining that an additional user of the additional users has a conflict with the meeting; and sending, based at least in part on determining that the additional user has the conflict with the meeting and to the additional user, a notification of the conflict.

E: The method of paragraph D, wherein the request to generate the meeting is associated with a first time, the method further comprising: determining that a number of the additional users is below a threshold number of users; determining, based at least in part on the one or more calendars, a second meeting time; and sending, to the user, the second meeting time as a suggested new meeting time for the meeting.

F: The method of paragraph A, further comprising: determining that an additional user of the additional users has a conflict with the meeting; and sending, based at least in part on determining that the additional user has the conflict with the meeting and to the additional user, a notification of the conflict.

G: The method of paragraph A, wherein the at least one response is an acceptance of the invitation by a first additional user of the additional users, the method further comprising: receiving, from the user, an indication of a duration of time after a start time associated with the meeting; determining that a current time is subsequent to the start time; determining, based at least in part on the current time being subsequent to the start time and that a second additional user of the additional users has joined the meeting, that the meeting has started; determining that the duration of time since the meeting has started has elapsed; and sending, to the first additional user, a reminder to join the meeting.

H: The method of paragraph A, wherein the at least one response includes at least one of: a first indication to accept the invitation; a second indication to decline the invitation; or a third indication of a proposed new time to associate with the meeting.

I: A system comprising: one or more processors; and one or more non-transitory computer-readable media comprising instructions that, when executed by the one or more processors, cause the system to perform operations comprising: receiving, from a user associated with a group-based communication platform, a request to generate a meeting between additional users of the group-based communication platform, wherein the user is included in, or excluded from, the additional users; inputting the request to generate the meeting into a machine-learning model; receiving, from the machine-learning model, a priority score associated with the meeting, wherein the priority score represents a determined importance of the meeting; determining, based at least in part on one or more calendars associated with the additional users, an availability of the additional users; sending, to the additional users, an invitation to the meeting, wherein the invitation includes the priority score; and receiving at least one response to the invitation from at least one additional user of the additional users.

J: The system of paragraph I, wherein the priority score is based at least in part on at least one of: an urgency associated with the meeting; a priority associated with the meeting; a duration of the meeting; a reoccurrence of the meeting; or a position or role of an additional user of the additional users.

K: The system of paragraph I, wherein the priority score is a first priority score, the operations further comprising: receiving, from the user, an indication to update the first priority score; receiving, from the user, a second priority score; and based at least in part on receiving the indication to update the first priority score, updating the first priority score to the second priority score.

L: The system of paragraph I, the operations further comprising: determining that an additional user of the additional users has a conflict with the meeting; and sending, based at least in part on determining that the additional user has the conflict with the meeting and to the additional user, a notification of the conflict.

M: The system of paragraph L, wherein the request to generate the meeting is associated with a first time, the operations further comprising: determining that a number of the additional users is below a threshold number of users; determining, based at least in part on the one or more calendars, a second meeting time; and sending, to the user, the second meeting time as a suggested new meeting time for the meeting.

N: The system of paragraph I, the operations further comprising: determining that an additional user of the additional users has a conflict with the meeting; and sending, based at least in part on determining that the additional user has the conflict with the meeting and to the additional user, a notification of the conflict.

O: One or more computer-readable media comprising instructions that, when executed by one or more processors, cause the one or more processors to perform operations comprising: receiving, from a user associated with a group-based communication platform, a request to generate a meeting between additional users of the group-based communication platform, wherein the user is included in, or excluded from, the additional users; inputting the request to generate the meeting into a machine-learning model; receiving, from the machine-learning model, a priority score associated with the meeting, wherein the priority score represents a determined importance of the meeting; determining, based at least in part on one or more calendars associated with the additional users, an availability of the additional users; sending, to the additional users, an invitation to the meeting, wherein the invitation includes the priority score; and receiving at least one response to the invitation from at least one additional user of the additional users.

P: The one or more computer-readable media of paragraph O, wherein the priority score is based at least in part on at least one of: an urgency associated with the meeting; a priority associated with the meeting; a duration of the meeting; a reoccurrence of the meeting; or a position or role of an additional user of the additional users.

Q: The one or more computer-readable media of paragraph O, wherein the priority score is a first priority score, the operations further comprising: receiving, from the user, an indication to update the first priority score; receiving, from the user, a second priority score associated with the meeting; and based at least in part on receiving the indication to update the first priority score, updating the first priority score to the second priority score.

R: The one or more computer-readable media of paragraph O, the operations further comprising: determining that an additional user of the additional users has a conflict with the meeting; and sending, based at least in part on determining that the additional user has the conflict with the meeting and to the additional user, a notification of the conflict.

S: The one or more computer-readable media of paragraph O, wherein the at least one response is an acceptance of the invitation by a first additional user of the additional users, the operations further comprising: receiving, from the user, an indication of a duration of time after a start time associated with the meeting; determining that a current time is subsequent to the start time; determining, based at least in part on the current time being subsequent to the start time and that a second additional user of the additional users has joined the meeting, that the meeting has started; determining that the duration of time since the meeting has started has elapsed; and sending, to the first additional user, a reminder to join the meeting.

T: The one or more computer-readable media of paragraph O, wherein the at least one response from the additional users includes at least one of: a first indication to accept the invitation; a second indication to decline the invitation; or a third indication of a proposed new time to associate with the meeting.

U: A method, implemented at least in part by one or more computing devices of a group-based communication platform, the method comprising: receiving, from a user associated with the group-based communication platform, a request to schedule a meeting between additional users of the group-based communication platform, wherein the user is included in, or excluded from, the additional users; sending, to the additional users, an invitation to the meeting; sending, based at least in part on determining that a period of time since a start time of the meeting has elapsed and that an additional user of the additional users has yet to join the meeting, a meeting reminder to the additional user; receiving an indication of one or more actions of the additional user in association with the meeting; generating, based at least in part on the indication of the one or more actions of the additional user and a determination that a current time is past an end time of the meeting, one or more meeting recommendations associated with the additional user; and sending the one or more meeting recommendations to at least one of the user or the additional user.

V: The method of paragraph A, wherein the one or more meeting recommendations include at least one of: removing the additional user from future meetings associated with the meeting; and sending additional reminders to the additional user in association with the future meetings.

W: The method of paragraph A, further comprising: receiving, from the user, one or more attributes associated with an additional user, wherein the one or more attributes include at least one of: a threshold number of meetings previously missed by the additional user; an average amount of time between a first start of one or more first previous meetings and the additional user joining the one or more first previous meetings being equal to or greater than a first threshold amount of time; or a total amount time between a second start of one or more second previous meetings and the additional user joining the one or more second previous meetings being equal to or greater than a second threshold amount of time; and determining that the additional user is associated with the one or more attributes; wherein sending the meeting reminder to the additional user is based at least in part on determining that the additional user is associated with the one or more attributes.

X: The method of paragraph A, wherein the one or more actions of the additional user include at least one of: attending the meeting; being absent from the meeting; joining the meeting after receiving the meeting reminder; and a duration of time between the start time of the meeting and the additional user joining the meeting.

Y: The method of paragraph A, wherein the period of time after the start time of the meeting is determined by the user.

Z: The method of paragraph A, wherein the period of time is a first period of time and the meeting reminder is a first meeting reminder sent at a first time, the method further comprising: determining, at a second time that is subsequent to the first time, that the additional user has not joined the meeting; determining that a second period of time since the start time of the meeting has elapsed; and sending, to the additional user, a second meeting reminder to join the meeting.

AA: The method of paragraph A, wherein the meeting reminder includes a selectable control associated with sending, to the user, at least one of: a first indication that the additional user is running late; a second indication that the additional user will not attend the meeting; or a third indication that the additional user has a meeting conflict with the meeting.

AB: The method of paragraph A, wherein sending the invitation to the additional users includes sending a priority score associated with the meeting, wherein the priority score is calculated by a machine-learning model associated with the group-based communication platform and based at least in part on at least one of: an urgency associated with the meeting; a priority associated with the meeting; a duration of the meeting; a reoccurrence of the meeting; or a position of at least one additional user of the additional users.

AC: The method of paragraph H, wherein the priority score is a first priority score, the method further comprising: receiving, from the user, an indication to update the first priority score; receiving, from the user, a second priority score; and based at least in part on receiving the indication to update the first priority score, updating the first priority score to the second priority score.

AD: A system comprising: one or more processors; and one or more non-transitory computer-readable media comprising instructions that, when executed by the one or more processors, cause the system to perform operations comprising: receiving, from a user associated with a group-based communication platform, a request to schedule a meeting between additional users of the group-based communication platform, wherein the user is included in, or excluded from, the additional users; sending, to the additional users, an invitation to the meeting; sending, based at least in part on determining that a period of time since a start time of the meeting has elapsed and that an additional user of the additional users has yet to join the meeting, a meeting reminder to the additional user; receiving an indication of one or more actions of the additional user in association with the meeting; generating, based at least in part on the indication of the one or more actions of the additional user and a determination that a current time is past an end time of the meeting, one or more meeting recommendations associated with the additional user; and sending the one or more meeting recommendations to at least one of the user or the additional user.

AE: The system of paragraph J, wherein the one or more meeting recommendations include at least one of: removing the additional user from future meetings associated with the meeting; and sending additional reminders to the additional user in association with the future meetings.

AF: The system of paragraph J, the operations further comprising: receiving, from the user, one or more attributes associated with an additional user, wherein the one or more attributes include at least one of: a threshold number of meetings previously missed by the additional user; an average amount of time between a first start of one or more first previous meetings and the additional user joining the one or more first previous meetings being equal to or greater than a first threshold amount of time; or a total amount time between a second start of one or more second previous meetings and the additional user joining the one or more second previous meetings being equal to or greater than a second threshold amount of time; and determining that the additional user is associated with the one or more attributes; wherein sending the meeting reminder to the additional user is based at least in part on determining that the additional user is associated with the one or more attributes.

AG: The system of paragraph J, wherein the one or more actions of the additional user include at least one of: attending the meeting; being absent from the meeting; joining the meeting after receiving the meeting reminder; and a duration of time between the start time of the meeting and the additional user joining the meeting.

AH: The system of paragraph J, wherein the period of time after the start time of the meeting is determined by the user.

AI: The system of paragraph J, wherein the period of time is a first period of time and the meeting reminder is a first meeting reminder sent at a first time, the operations further comprising: determining, at a second time that is subsequent to the first time, that the additional user has not joined the meeting; determining that a second period of time since the start time of the meeting has elapsed; and sending, to the additional user, a second meeting reminder to join the meeting.

AJ: One or more computer-readable media comprising instructions that, when executed by one or more processors, cause the one or more processors to perform operations comprising: receiving, from a user associated with a group-based communication platform, a request to schedule a meeting between additional users of the group-based communication platform, wherein the user is included in, or excluded from, the additional users; sending, to the additional users, an invitation to the meeting; sending, based at least in part on determining that a period of time since a start time of the meeting has elapsed and that an additional user of the additional users has yet to join the meeting, a meeting reminder to the additional user; receiving an indication of one or more actions of the additional user in association with the meeting; generating, based at least in part on the indication of the one or more actions of the additional user and a determination that a current time is past an end time of the meeting, one or more meeting recommendations associated with the additional user; and sending the one or more meeting recommendations to at least one of the user or the additional user.

AK: The one or more computer-readable media of paragraph P, wherein the meeting reminder includes a selectable control associated with sending, to the user of the group-based communication platform, at least one of: a first indication that the additional user is running late; a second indication that the additional user will not attend the meeting; or a third indication that the additional user has a meeting conflict with the meeting.

AL: The one or more computer-readable media of paragraph P, wherein sending the invitation to the additional users includes sending a priority score associated with the meeting, wherein the priority score is calculated by a machine-learning model associated with the group-based communication platform and based at least in part on at least one of: an urgency associated with the meeting; a priority associated with the meeting; a duration of the meeting; a reoccurrence of the meeting; or a position of at least one additional user of the additional users.

AM: The one or more computer-readable media of paragraph R, wherein the priority score is a first priority score, the operations further comprising: receiving, from the user, an indication to update the first priority score; receiving, from the user, a second priority score; and based at least in part on receiving the indication to update the first priority score, updating the first priority score to the second priority score.

AN: The one or more computer-readable media of paragraph P, wherein the one or more meeting recommendations include at least one of: removing the additional user from future meetings associated with the meeting; and sending additional reminders to the additional user in association with the future meetings.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method, implemented at least in part by one or more computing devices of a group-based communication platform, the method comprising:
receiving, from a user associated with the group-based communication platform, a request to generate a meeting between additional users of the group-based communication platform, wherein the user is included in, or excluded from, the additional users;
inputting the request to generate the meeting into a machine-learning model;
receiving, from the machine-learning model, a priority score associated with the meeting, wherein the priority score represents a determined importance of the meeting;
determining, based at least in part on one or more calendars associated with the additional users, an availability of the additional users;
sending, to the additional users, an invitation to the meeting, wherein the invitation includes the priority score; and
receiving at least one response to the invitation from at least one additional user of the additional users.

2. The method of claim 1, wherein the priority score is based at least in part on at least one of:
an urgency associated with the meeting;
a priority associated with the meeting;
a duration of the meeting;
a reoccurrence of the meeting; or
a position or role of an additional user of the additional users.

3. The method of claim 1, wherein the priority score is a first priority score, the method further comprising:
receiving, from the user, an indication to update the first priority score;
receiving, from the user, a second priority score associated with the meeting; and
based at least in part on receiving the indication to update the first priority score, updating the first priority score to the second priority score.

4. The method of claim 1, further comprising:
determining that an additional user of the additional users has a conflict with the meeting; and
sending, based at least in part on determining that the additional user has the conflict with the meeting and to the additional user, a notification of the conflict.

5. The method of claim 4, wherein the request to generate the meeting is associated with a first time, the method further comprising:
determining that a number of the additional users is below a threshold number of users;
determining, based at least in part on the one or more calendars, a second meeting time; and
sending, to the user, the second meeting time as a suggested new meeting time for the meeting.

6. The method of claim 1, further comprising:
determining that an additional user of the additional users has a conflict with the meeting; and
sending, based at least in part on determining that the additional user has the conflict with the meeting and to the additional user, a notification of the conflict.

7. The method of claim 1, wherein the at least one response is an acceptance of the invitation by a first additional user of the additional users, the method further comprising:
receiving, from the user, an indication of a duration of time after a start time associated with the meeting;
determining that a current time is subsequent to the start time;
determining, based at least in part on the current time being subsequent to the start time and that a second additional user of the additional users has joined the meeting, that the meeting has started;
determining that the duration of time since the meeting has started has elapsed; and
sending, to the first additional user, a reminder to join the meeting.

8. The method of claim 1, wherein the at least one response includes at least one of:
a first indication to accept the invitation;
a second indication to decline the invitation; or
a third indication of a proposed new time to associate with the meeting.

9. A system comprising:
one or more processors; and
one or more non-transitory computer-readable media comprising instructions that, when executed by the one or more processors, cause the system to perform operations comprising:
receiving, from a user associated with a group-based communication platform, a request to generate a meeting between additional users of the group-based communication platform, wherein the user is included in, or excluded from, the additional users;
inputting the request to generate the meeting into a machine-learning model;
receiving, from the machine-learning model, a priority score associated with the meeting, wherein the priority score represents a determined importance of the meeting;
determining, based at least in part on one or more calendars associated with the additional users, an availability of the additional users;
sending, to the additional users, an invitation to the meeting, wherein the invitation includes the priority score; and
receiving at least one response to the invitation from at least one additional user of the additional users.

10. The system of claim 9, wherein the priority score is based at least in part on at least one of:
an urgency associated with the meeting;
a priority associated with the meeting;
a duration of the meeting;
a reoccurrence of the meeting; or
a position or role of an additional user of the additional users.

11. The system of claim 9, wherein the priority score is a first priority score, the operations further comprising:
receiving, from the user, an indication to update the first priority score;
receiving, from the user, a second priority score; and
based at least in part on receiving the indication to update the first priority score, updating the first priority score to the second priority score.

12. The system of claim 9, the operations further comprising:
determining that an additional user of the additional users has a conflict with the meeting; and
sending, based at least in part on determining that the additional user has the conflict with the meeting and to the additional user, a notification of the conflict.

13. The system of claim 12, wherein the request to generate the meeting is associated with a first time, the operations further comprising:
determining that a number of the additional users is below a threshold number of users;
determining, based at least in part on the one or more calendars, a second meeting time; and
sending, to the user, the second meeting time as a suggested new meeting time for the meeting.

14. The system of claim 9, the operations further comprising:
determining that an additional user of the additional users has a conflict with the meeting; and
sending, based at least in part on determining that the additional user has the conflict with the meeting and to the additional user, a notification of the conflict.

15. One or more computer-readable media comprising instructions that, when executed by one or more processors, cause the one or more processors to perform operations comprising:
receiving, from a user associated with a group-based communication platform, a request to generate a meeting between additional users of the group-based communication platform, wherein the user is included in, or excluded from, the additional users;
inputting the request to generate the meeting into a machine-learning model;
receiving, from the machine-learning model, a priority score associated with the meeting, wherein the priority score represents a determined importance of the meeting;
determining, based at least in part on one or more calendars associated with the additional users, an availability of the additional users;
sending, to the additional users, an invitation to the meeting, wherein the invitation includes the priority score; and
receiving at least one response to the invitation from at least one additional user of the additional users.

16. The one or more computer-readable media of claim 15, wherein the priority score is based at least in part on at least one of:
an urgency associated with the meeting;
a priority associated with the meeting;
a duration of the meeting;
a reoccurrence of the meeting; or
a position or role of an additional user of the additional users.

17. The one or more computer-readable media of claim 15, wherein the priority score is a first priority score, the operations further comprising:
receiving, from the user, an indication to update the first priority score;
receiving, from the user, a second priority score associated with the meeting; and
based at least in part on receiving the indication to update the first priority score, updating the first priority score to the second priority score.

18. The one or more computer-readable media of claim 15, the operations further comprising:
determining that an additional user of the additional users has a conflict with the meeting; and
sending, based at least in part on determining that the additional user has the conflict with the meeting and to the additional user, a notification of the conflict.

19. The one or more computer-readable media of claim 15, wherein the at least one response is an acceptance of the invitation by a first additional user of the additional users, the operations further comprising:
receiving, from the user, an indication of a duration of time after a start time associated with the meeting;
determining that a current time is subsequent to the start time;
determining, based at least in part on the current time being subsequent to the start time and that a second additional user of the additional users has joined the meeting, that the meeting has started;
determining that the duration of time since the meeting has started has elapsed; and
sending, to the first additional user, a reminder to join the meeting.

20. The one or more computer-readable media of claim 15, wherein the at least one response from the additional users includes at least one of:
a first indication to accept the invitation;
a second indication to decline the invitation; or
a third indication of a proposed new time to associate with the meeting.
